(19) United States
(12) Patent Application Publication
(10) Pub. No.: US 2026/0209424 A1
(43) Pub. Date: Jul. 23, 2026

(54) MODULAR REACTOR FOR SYNTHESIS

(71) Applicant: AUROTEC GMBH, Regau (AT)

(72) Inventors: Paul AIGNER, Lenzing (AT); Christoph Manuel MUGRAUER, Kirchberg-Thening (AT); Stefan ZIKELI, Regau (AT)

(21) Appl. No.: 19/138,864

(22) PCT Filed: Dec. 15, 2023
(86) PCT No.: PCT/EP2023/086076

§ 371 Date: Jun. 13, 2025

(30) Foreign Application Priority Data
Dec. 15, 2022 (EP) 22213726.7

(51) Int. Cl. C08G 18/08; B01J 19/00; C08G 18/10; C08G 18/30; C08G 18/70

(52) U.S. Cl. CPC C08G 18/0895; B01J 19/0093; C08G 18/10; C08G 18/30; C08G 18/70; B01J 2219/00792; B01J 2219/0086; B01J 2219/00889

(57) ABSTRACT

A continuous method for producing a prepolymer in a reactor having an elongated hollow body, wherein at least two reactants are introduced continuously at one end of a reaction zone of the hollow body, the at least two reactants are polymerized with one another in the reaction zone, and prepolymer is discharged at another end of the reaction zone, wherein the elongated hollow body comprises at least a first and a second partial region in the reaction zone, wherein the hollow body has an inner diameter in the second partial region at least 10% larger than the inner diameter of the hollow body in the first partial region, and the second partial region has a length larger than or equal to the length of the first partial region; and to a reactor for such a method is disclosed.

The present invention relates to a continuous method for producing polyurethane prepolymers.

### BACKGROUND OF THE INVENTION

Prepolymers are reactive oligomers or short-chain polymers that are used to produce long-chain polymers. They are precursors that, unlike the end product, are still soluble or easily melted. Prepolymers allow the production of block copolymers or shaping processing before solidification by crosslinking or progressive polymerization leads to a more solid state. Correspondingly, a prepolymer can also be a finished polymer with low molar masses. Finished prepolymers with low molecular weights are often used as stabilizers or auxiliaries.

Different conditions in the production of the prepolymers enable a wide range of mechanical properties. This ranges from soft elastic foams and fibres to solid mouldings with high impact strength. This shows the already very large scope of application, which is continuously evolving.

A method for the continuous production of prepolymers is disclosed, for example, in WO 2007/037824 A2.

EP 1391472 A1 describes a method for the continuous production of thermoplastically processable polyurethanes, in which at least two different polyols and chain extenders are used in combination with an isocyanate. Polyurethanes can be produced stepwise (prepolymer dosing method) or by the simultaneous reaction of all components in one step (one-shot dosing method). A continuously operated extruder is used, as also described in WO 2007/101807 A1 or WO 2021/122303 A1. The aim here is to produce the finished moulding directly. The extruder is accompanied by high temperatures of around 150-300° C. Such high temperatures are disadvantageous for a precise adjustment of the properties of prepolymers.

Polyurethanes are products that are formed during the polyaddition of mostly (poly)isocyanates with (poly)alcohols. The connecting unit is the urethane group. The urethane group may also connect sequences of other functional groups (polyesters, polyethers, or others). In addition to the urethane group, the polymerization of polyurethanes can also (specifically) form urea, imide, amide or isocyanurate groups, depending on the reactant.

U.S. Pat. No. 7,795,359 describes the continuous production of various prepolymers in a spiral microreactor with a micromixer. In order to avoid high molecular weight polymers, an ultrasound treatment is carried out. The spiral shape leads to a high pressure loss and limits the reaction control, such as for setting a certain product composition or viscosity.

EP 1669385 A1 describes a continuous method for the synthesis of an acid-functional blocked isocyanate.

U.S. Pat. No. 5,471,037 A describes a method for producing polymers in a tubular reactor, wherein a static mixer is used upstream of a reaction zone of the tubular reactor.

EP 2287228 A2 describes the production of a silylated prepolymer. For the synthesis, a tubular reactor with an internal static mixer is described. Several reactors can be connected in series, wherein catalysts or silylating reagents are fed in between the reactors. A length/diameter ratio of 10:1 to 50:1 is mentioned as the reactor dimension. The reaction temperature is between 8° and 200° C. No information is given about the exact reactor sizes in the examples, nor about characteristic product properties, such as molar mass and molar mass distribution.

JP 2019-202477 A describes a method for coating a laminate with an adhesive.

In order to be able to control the product quality a little better, circular reactors are used in WO 2021/122284 A1. Here, a partial stream is fed back into the reactor. At the same time, product is continuously drawn off. This makes it possible to at least partially influence the product quality. However, the possibilities of influencing the overall product quality are limited.

Previous reactor systems show disadvantages with different and poorly adjustable product properties, harmful side reactions that lead to gel formation and, if necessary, reactor blocking after repeated experiments.

### SUMMARY OF THE INVENTION

It is an object of the present invention to improve process control, uniform product properties (reproducible adjustment of desired product molar mass and molar mass distribution) and problems with by-products that lead to reactor maintenance costs. It is also an object of the present invention to provide a scalable process for the production of prepolymers, in particular polyurethane prepolymers, which enables a high yield, low to no by-products and degradation products and efficient conversion.

The invention relates to a continuous method for producing a prepolymer in a reactor having an elongated hollow body, wherein at least two reactants are introduced continuously at one end of a reaction zone of the hollow body, the at least two reactants are polymerized with one another in the reaction zone, and prepolymer is discharged at another end of the reaction zone, wherein the elongated hollow body comprises at least a first and a second partial region in the reaction zone, wherein the hollow body has an inner diameter in the second partial region at least 10% larger than the inner diameter of the hollow body in the first partial region. Preferably, the second partial region has a length that is larger than or equal to the length of the first partial region.

Preferably, in all embodiments of the invention, the prepolymer is a polyurethane prepolymer. One of the reactants comprises at least one alcohol group and one of the reactants comprises at least one isocyanate group. In particular, the invention therefore relates to a continuous method for producing a polyurethane prepolymer in a reactor having an elongated hollow body, wherein at least two reactants are introduced continuously at one end of a reaction zone of the hollow body, the at least two reactants are polymerized in the reaction zone, and prepolymer is discharged at another end of the reaction zone, wherein one of the reactants comprises at least one alcohol group and one of the reactants comprises at least one isocyanate group, wherein the elongated hollow body comprises at least a first and a second partial region in the reaction zone, wherein the hollow body has an inner diameter in the second partial region at least 10% larger than the inner diameter of the hollow body in the first partial region. Preferably, the second partial region has a length that is larger than or equal to the length of the first partial region.

The invention further relates to a continuous method for producing a polyurethane prepolymer in a reactor having an elongated hollow body, wherein at least two reactants are introduced continuously at one end of a reaction zone of the hollow body, the at least two reactants are polymerized in the reaction zone, and prepolymer is discharged at another end of the reaction zone, wherein one of the reactants comprises at least one alcohol group and at least one of the reactants comprises one isocyanate group, wherein the reactor is operated with a temperature (T), a residence time (t), and an optional molar excess of a reactant (c), so that a targeted average molecular weight of the prepolymer of 5000 Da to 80,000 Da according to the formula

$${M}_{k} ( T , t , c ) = {A}_{T} * {e}^{{K}_{T} * T} + {A}_{t} * t - {A}_{c} * c$$

wherein
Mₖ(T, t, c) is the targeted average molecular weight of the prepolymer,
A(T) is 0.00039 Da,
K(T) is 0.05733 K⁻¹,
A(t) is 1354 Da min⁻¹,
A(c) is 534 Da mol⁻¹,
T is the temperature in K,
t is the residence time in min,
c is the molar excess of a reactant in mol-%,
is obtained.

The invention further relates to a reactor suitable for carrying out a method according to the invention, wherein the reactor has an elongated hollow body, with an inlet at one end and an outlet at another end of the hollow body, wherein the elongated hollow body comprises at least a first and a second partial region, wherein the hollow body in the first partial region has an inner diameter of <2.2 mm and the hollow body in the second partial region has an inner diameter of ≥2.2 mm, wherein the hollow body has an inner diameter in the second partial region at least 10% larger than the inner diameter of the hollow body in the first partial region, the first and second partial regions, independently of one another, each have a length of ≥1 m. Preferably, the second partial region has a length that is larger than or equal to the length of the first partial region.

All these aspects of the invention can be combined with one another, e.g. descriptions of the method according to the invention can represent the suitability of the reactor according to the invention. The reactor can be used in the method according to the invention. Therefore, the following detailed description relates to both the method and the reactor, even if only one of the two aspects is explicitly referred to.

### DETAILED DESCRIPTION OF THE INVENTION

The invention relates to a continuous method for producing a prepolymer in a reactor having an elongated hollow body. The reactor is also referred to as a microreactor, because the elongated hollow body is usually thin tubes or hoses, i.e. hollow bodies with a length that is many times larger than width/diameter, e.g. with a length-to-width (or diameter) ratio of 50:1 to 20,000:1, in particular 100:1 to 10,000:1, or 200:1 to 5000:1, especially preferably 400:1 to 2000:1. This ratio should be present in particular in a reactor zone of the hollow body. In the case of staggered widths/diameters in partial regions, the width/diameter of the respective partial region is used aliquot of the length of the partial region to the total length of the hollow body or the reactor zone or the average of the width/diameter. Particularly effective reactions are possible in these thin hollow bodies.

The tubes may have different cross-sections, e.g., round, elastic, rectangular, square, and mixed shapes thereof.

The tubes are essentially round, cylindrical or prismatic, i.e. in a partial region with a given width/diameter, this width/diameter should remain constant. Mixing elements, e.g. due to tube compression, are avoided, e.g. are present over less than 5% of the length, preferably less than 1% of the length of the hollow body or the reactor zone, or are completely avoided. The hollow body, on the other hand, can be curved in order to accommodate the reactor compactly, for example.

For simplicity, the term “inner diameter” is used herein for the inner width or diameter of the hollow body, meaning the average dimension in the cross-section of the hollow body, wherein the shape may be different, as mentioned above, round, elliptical, rectangular, square, and mixed shapes thereof. This means that when a diameter is mentioned below, this also means a description of the width, without limitation to a circular cross-sectional shape, unless this is explicitly mentioned. The invention comprises cross-sectional sizes which have the same cross-sectional area as the cross-sectional area for a specified diameter, such as an inner diameter, for a circular cross-section.

In methods according to the invention, at least two reactants are introduced continuously at one end of a reaction zone of the hollow body, the at least two reactants are polymerized to prepolymer in the reaction zone, and prepolymer is discharged at another end of the reaction zone.

The elongated hollow body should comprise at least a first and a second partial region in the reaction zone, wherein the hollow body preferably has an inner diameter in the second partial region at least 10% larger than the inner diameter of the hollow body in the first partial region, and the second partial region has a length larger than or equal to the length of the first partial region. As a result, with a larger diameter in the second partial region, even with the same length of the second partial region compared to the first partial region, the volume of the reaction zone in the second partial region increases and has a volume that is 21 percent larger than the volume of the first partial region (e.g. D1=1/D2=1.1>d²=1.21).

Particularly preferably, the second partial region has a volume (internal volume) larger than the volume of the first partial region, preferably wherein the second partial region has a volume larger than the volume of the first partial region by at least 5%, preferably by at least 10%. An increasing volume from one partial region to the next leads to particularly stable production conditions, especially in the case of prepolymers.

The two reactants are usually mixed in the reactor at the beginning of the reaction zone, so that they can only react with each other here. In other cases, they can be mixed beforehand, i.e. if they do not react immediately after mixing, e.g. in the case when the conditions for a reaction are only created in the reaction zone, e.g. by a required, higher temperature and/or the presence of a catalyst.

In particularly preferred cases, the prepolymer is a polyurethane prepolymer. For the production of polyurethane, at least one of the reactants preferably comprises at least one alcohol group, preferably two or more, and at least one of the reactants comprises at least one isocyanate group, preferably two or more. Preferably, an reactant with two alcohol groups and an reactant with two isocyanate groups is used. Additional reactants with three or more alcohol groups and/or three or more isocyanate groups can be added as crosslinkers, preferably in a smaller amount than the reactants with two alcohol or two isocyanate groups.

The invention further relates to a reactor suitable for carrying out a method according to the invention. A preferred reactor according to the invention has an elongated hollow body with an inlet at one end and an outlet at another end of the hollow body. The hollow body has a staggered inner diameter, i.e. at least two partial regions with different inner diameters. The elongated hollow body comprises at least a first and a second partial region, wherein the hollow body in the first partial region preferably has an inner diameter of <(less than) 2.2 mm and the hollow body in the second partial region has an inner diameter of ≥(larger than or equal to) 2.2 mm, wherein the hollow body has an inner diameter in the second partial region at least 10% larger than the inner diameter of the hollow body in the first partial region. Furthermore, the first and second partial regions preferably each have a length of ≥ (larger than or equal to) 1 m, independently of one another. The second partial region has a length that is larger than or equal to the length of the first partial region. The reactor can be used with or without the preferred features for the method according to the invention. These specified diameters and lengths of the partial regions enable a particularly preferred implementation of the production of prepolymers, with reduced side reactions and the advantage of lower blockages of the reactor, which thus benefits from a higher reusability without intermediate flushing.

Preferably, the inner diameter in the second partial region is larger than the inner diameter of the first partial region by at least 20%, preferably by at least 30%, particularly preferably by at least 40%, particularly preferably by at least 50%. Such an increase in the inner diameter in the second partial region compared to the first partial region is associated with particularly pronounced advantages, as described above.

Preferably, the second partial region is longer than the first partial region. Particularly preferably, the second partial region has a length that is at least 10% larger than the length of the first partial region. Preferably, the partial region is at least 20%, particularly preferably at least 40%, or at least 60%, or even at least 80%, longer than the first partial region.

In principle, the aforementioned partial regions describe longitudinal regions in the elongated hollow body that have the aforementioned relative dimensions with respect to one another. These partial regions can in principle be positioned at any desired point in the hollow body. In this case, the first partial region is positioned in front of the second partial region, so that there is a widening of the inner diameter in the course from the inlet to the outlet. The first partial region is preferably at the inlet into the reaction zone. Alternatively, or combined with this, the second partial region is on outlet from the reaction zone.

According to the specifications for the first and second partial regions, the inner diameter can have these two inner diameter graduations. In further embodiments, the inner diameter has at least 3 diameter graduations over the length of the reaction zone. The first and second partial regions mentioned here form regions in these at least 3 graduations. In this case, the first and/or second partial region may have one or more partial regions in order to form further diameter graduations. The entire partial region, together with the partial region, fulfils the relative or absolute dimensions mentioned (e.g. inner diameter larger or smaller than in the other partial region mentioned). Alternatively, or in combination therewith, a further partial region may be provided which has dimensions other than those specified so far. For example, an intermediate partial region (or “central partial region”) between the first and second partial regions, which has differences in size from the others, in particular first and second partial regions, other than those mentioned. However, the inner diameter should always increase from the inlet to the outlet, i.e. an intermediate partial region should not have a smaller inner diameter than a partial region previously (in the direction of the inlet) and no larger inner diameter than a subsequent partial region (in the direction of the outlet). Such an intermediate partial region, or also referred to as a central partial region, can be provided between the first and second partial regions, wherein the central partial region has an inner diameter that is larger than the inner diameter of the first partial region and smaller than the inner diameter of the second partial region. Preferably, the central partial region has a length of at least 30 cm. The inner diameter of the central partial region may be at least 5%, preferably at least 10%, larger than the inner diameter of the first partial region; the inner diameter of the second partial region may be at least 5%, preferably at least 10%, larger than the inner diameter of the central partial region.

In preferred embodiments, the second partial region comprises subregions with at least two different inner diameters, wherein a subregion closer to the first partial region (in the direction of the inlet) has a smaller inner diameter than a subregion further from the first partial region (in the direction of the outlet). Preferably, each of the subregions has a length of at least 30 cm.

In preferred embodiments, the first partial region comprises subregions with at least two different inner diameters, wherein a subregion closer to the second partial region (in the direction of the outlet) has a larger inner diameter than a subregion further from the second partial region (in the direction of the inlet). Preferably, each of the subregions has a length of at least 30 cm.

Further graduations with intermediate inner diameters are possible.

Preferably, the reaction zone has a length of at least 50 cm, preferably of at least 1 m. Likewise, the hollow body in the first partial region preferably has an inner diameter of <2.2 mm, preferably <2.0 mm, and/or the hollow body in the second partial region has an inner diameter of ≥2.2 mm, preferably ≥2.6 mm. For example, the inner diameter in the first partial region can be 1.4 mm to 2.1 mm and the inner diameter in the second partial region can be 2.2 mm to 18 mm. The partial regions meet the diameter specifications over their entire length. Of course, the relative requirement of a diameter that is at least 10% larger will continue to be met. That is, with an inner diameter of 2.1 mm in the first partial region, the inner diameter in the second partial region is at least 2.31 mm.

Preferably, the reaction zone has a volume of at least 25 ml, preferably of at least 100 ml, particularly preferably of at least 500 ml Alternatively or in combination therewith, the reaction zone preferably has a volume of at most 5 l, preferably of at most 3 l, particularly preferably of at most 2 l. For example, the volume of the reaction zone may be 25 ml to 2 l. The volume of the reaction zone is considered to be the volume of the zone of the hollow body in which the conditions for polymerization prevail or can be purified, e.g. from the inlet to the outlet. At the inlet, the reactants are usually combined. At the outlet, prepolymer and any unreacted reactants are discharged from the reactor.

The residence time in the reactor can be determined or adjusted by volume and throughput (or flow rate). The residence time of the reactants polymerizing to prepolymer and polymerized in the reaction zone is preferably at least 2 min, preferably at least 3 min or at least 4 min, e.g. 2 min to 15 min, preferably 3 min to 12 min, particularly preferably 4 min to 10 min. During these times, a good polymerization to prepolymer can be established, e.g. by selecting a suitable temperature, reactant concentrations and optionally a catalyst. Preferably, according to the invention, no catalyst is added to reactant fluids. Likewise, no specific catalyst is preferably used on the hollow body wall. A specific catalyst is specially prepared for polymerization. According to the invention, the hollow body is a metal body which is not specifically intended to accelerate polymerization. Nevertheless, it may happen that polymerization takes place on its surface.

Preferably, the reactants are introduced into the reaction zone in a solution. The concentration of the reactants together is preferably 20% to 60% (mass-%). “Together” means that the concentration of the individual reactants is added. After polymerization, the reactant concentration then also corresponds to the concentration of the prepolymer (in mass-%), in the case of complete polymerization. In the case of incomplete polymerisation, the prepolymer is present after the outlet in a lower concentration than the reactants together at the inlet. The polymerization can easily be adjusted in the reactor according to the invention with the specified mass-%. This concentration also fits well with the abovementioned residence times. In particularly preferred embodiments, the concentration of the reactants together is 24% to 56%, particularly preferably 30% to 50% (all mass-%).

Preferably, one of the reactants is introduced into the reaction zone in an excess over another of the reactants. It is particularly preferably introduced with an excess of at least 3% (mol-%), preferably 5% (mol-%), particularly preferably at least 10% (mol-%) or even at least 20% (mol-%). Preferably, the excess of one reactant over another reactant (with other functionalities, e.g. NCO with the excess reactant with OH functionalities) is between 2-30%, preferably between 5-22% (mol %). A molar excess can lead to a targeted molar mass distribution and, in particular, a maximum molar mass in the prepolymer produced. This is often desired so that the prepolymer remains soluble. In the production of polyurethane prepolymer, the reactant with one or more (especially two) alcohol groups is preferably in excess.

Preferably, the temperature in the reaction zone is 20° C. to 80° C., preferably 30° C. to 70° C. or 35° C. to 60° C., especially preferably 40° C. to 55° C., or any ranges between these values. The reactor may comprise a heating means for heating the hollow body. With these temperatures, the polymerization can be controlled well without leading to too rapid polymerizations to high molar masses or with little or no undesired side reactions.

In the production of a prepolymer, preferably a polyurethane prepolymer, the reactor is preferably operated with a temperature (T), a residence time (t), and an optional molar excess of a reactant (c), so that a targeted average molecular weight of the prepolymer of 5000 Da to 80,000 Da according to the formula

$${M}_{k} ( T , t , c ) = {A}_{T} * {e}^{{K}_{T} * T} + {A}_{t} * t - {A}_{c} * c$$

wherein Mₖ(T, t, c) is the targeted average molecular weight of the prepolymer, A(T) is 0.00039 Da, K(T) is 0.05733 K⁻¹, A(t) is 1354 Da min⁻¹, A(c) is 534 Da mol-, T is the temperature in K, t is the residence time in min, c is the molar excess of a reactant in mol-%, is obtained. Temperature (T), residence time (t), and molar excess can be easily adjusted and matched to meet the above formula. Temperature (T), residence time (t), and molar excess may be within the above ranges, for example. This allows the molar mass of the product to be predicted well (with blur deviations) and set well.

All the above parameters and structural characteristics of the reactor are preferably used in polyurethane prepolymer production.

The reactants for polyurethane production are mainly (poly)isocyanates and (poly)alcohols (e.g. polyester, polyether, polycarbonate polyols). The isocyanates may have one or more isocyanate (NCO) functionality. (Poly)alcohols have one or more alcohol (OH, hydroxy) groups. The hydrogen of the alcohol group, which is suitable for polymerization with the isocyanate group, may be a Zerewitinoff-active hydrogen.

In addition, the reactants, e.g. the isocyanate or the alcohol, may have special molecular building blocks such as ethanolamines, carboxylic acids, alkenes, organosulfones or chlorosulfones. Frequently, polymers thereof with a low degree of polymerization, so that the polymers are soluble and preferably have a low viscosity in solution, are already used. For example, polymeric reactants at a concentration (mass-%) in DMAC as solvent may have a Brookfield viscosity of no more than 200 mPas, preferably from 1 mPAs to 150 mPAs, at 25° C. Such polymeric reactants may also be used in other concentrations or other solvents.

Catalysts may optionally be used for polymerization in the reactor according to the invention. Catalysts are, for example, organic Lewis bases, Lewis acids, phosphates or (organic) metal salts/oxides. Such catalysts or catalysts in general may also be avoided.

As reactants, NCO-functionalized reactants are combined with OH-functionalized reactants. The reactants may be NCO- or OH-functionalized one or more times. Typical but not limited examples are NCO-terminated reactants, such as methylene diphenyl isocyanate (MDI), hexamethylene diisocyanate (HDI), toluene-2,4-diisocyanate (TDI), p-toluenesulfonyl isocyanate (TSI) and their isomers. Typical but not limited examples are OH-terminated reactants, such as methyldiethanolamine (MDEA), diethanolamine (DEA), tert-butyldiethanolamines (TBDEA), glycols, e.g. ethylene glycol, alkyl alcohol (e.g. C₂₋₁₀ alcohol, e.g. EtOH) and polyols.

Preferably, the (or an) isocyanate reactant is an organic diisocyanate. Suitable organic diisocyanates are, for example, aliphatic, cycloaliphatic, heterocyclic and aromatic diisocyanates. Aliphatic diisocyanates are, for example, branched or unbranched C₂-C₁₈-alkyl diisocyanate, such as hexamethylene diisocyanate. Cycloaliphatic diisocyanates are, for example, isophorone diisocyanate, 1,4-cyclohexane diisocyanate, 1-methyl-2,4- and -2,6-cyclohexane diisocyanate and the corresponding isomer mixtures, 4,4′-, 2,4′- and 2,2′-dicyclohexylmethane diisocyanate and the corresponding isomer mixtures. Aromatic diisocyanates are, for example, 4,4-methylenebis (phenyl isocyanate), 2,4-tolylene diisocyanate, mixtures of 2,4- and 2,6-tolylene diisocyanate, 4,4′-diphenylmethane diisocyanate, 2,4′-diphenylmethane diisocyanate and 2,2′-diphenylmethane diisocyanate, mixtures of 2,4′-diphenylmethane diisocyanate and 4,4′-diphenylmethane diisocyanate, urethane-modified liquid 4,4′-diphenylmethane diisocyanates and/or 2,4′-diphenylmethane diisocyanates, 4,4′-diisocyanatodiphenyl-ethane-(1,2) and 1,5-naphthylene diisocyanate. 4,4-Methylenebis (phenyl isocyanate) (“MDI”) is preferred.

Preferably, the (or an) alcohol reactant is an organic diol. Preferred diols are methyldiethanolamine (“MDEA”) and tert-butyldiethanolamine (“TBDEA”).

A polyurethane prepolymer is preferably produced in an isothermally controlled reactor. In all embodiments of the invention, and also in this embodiment, the elongated hollow body is preferably a tube for polyurethane prepolymer synthesis. The synthesis process may be carried out as follows.

The reactants are presented in suitable containers. Depending on the state of aggregation and product quality, solvents are used for the reactants. Preferably, only liquid components are used or the reactants are introduced into the reactor in liquid form. If necessary, the reactants may also be preheated. The temperature of the reactants is preferably between 0-80° C. or 10-70° C., preferably 20-60° C., or combinations of these ranges.

The storage and/or treatment upstream of the reaction zone of the reactants is preferably carried out under inert conditions, which are preferably (i. a.) anhydrous conditions. For inert conditions, the storage contents for the reactants are flushed with inert gas and the reactants are superimposed with inert gas. In addition, the storage takes place with or without stabilizer. For example, toluene-2,4-diisocyanate (TSI) or similar components may be used as a stabilizer.

One or more of the reactants is preferably used in dissolved form. The isocyanate and/or the alcohol are particularly preferably used in dissolved form.

Known aprotic polar substances, for example DMAc, tetrahydrofuran (THF), dimethyl sulfoxide (DMSO), or dimethylformamide (DMF), can be used as solvents.

With pumps, e.g. diaphragm, piston or gear pumps, two or more reactants can be transported and brought together in the reactor. The decision which pumps are used is ultimately purely a matter of the scaling factor or the viscosity of the respective reactant. Preferably, no mixing elements are used during the merging process. Reactants are preferably supplied only via a branch line.

In preferred embodiments, the flow profile in the hollow body, in particular in the reaction zone, is laminar. A laminar flow can be adjusted by selecting the flow velocity, viscosity (again depending on solvent, reactant concentration and temperature).

The structure of the elongated hollow body preferably consists of one or more tubular elements, which are lined up in a row. The tube elements may have an inner diameter of 0.5 mm to 20 mm, preferably 1 mm to 12 mm. As already described above, different inner diameters are used in the partial regions. The aim is to increase the diameter as the reaction progresses, in order to reduce the effect of the heat tone and at the same time to generate a minimum of pressure loss. As the reaction progresses and the prepolymer product concentration increases, the viscosity increases. This viscosity can be compensated for by the staggering of the inner diameter according to the invention. The length of a partial region, e.g. a tubular element, is preferably 0.1 m to 7 m, preferably 0.3 m to 5.8 m, e.g. 0.8 m to 3 m. The elongated hollow bodies can have a cross-sectional length of 0.1 m to 7 m, preferably 0.3 m to 5.8 m.

The elongated hollow body, in particular tubes, may have one or more bends, in particular J-type bends. The hollow body is largely rectilinear (e.g. in >70%, preferably <80%, of its length), but may have bends to accommodate the overall length in a compact form, e.g. on or in plates. In sum, the resulting shape of the entire hollow body, e.g. in the case of several J-type bent tubes, may be a meander shape. Preferably, no mixers, in particular no static mixers, are used in the elongated hollow body or in the reaction zone. Mixers may be, for example, baffle plates with an otherwise straight hollow body. A laminar flow in the reaction zone is preferably set (with appropriate structural measures without a mixer, which can cause turbulence, and/or with an appropriate flow rate at a given viscosity).

Preferably, the first and second partial regions each have a length of ≥1 m, independently of one another, and the second partial region has a length that is larger than or equal to the length of the first partial region, as already explained above. The length of the elongated hollow body or reaction zone may be up to 120 m or more, e.g., up to 240 m or more. Preferably, the hollow body or the reaction zone has a length of at least 2 m, at least 3 m, at least 5 m, at least 8 m, at least 10 m, at least 15 m, particularly preferably (especially for industrial applications) at least 20 m, or even at least 25 m.

Examples of the staggering according to the invention in hollow bodies or reaction zones are with the following dimensions. These are examples of the present invention and further alternatives are possible within the overall concept according to the invention.
1. first partial region: Inner diameter 1.5 mm to 2.15 mm, length 1 m to 50 m; second partial region: Inner diameter 2.3 mm to 6 mm, length 1 m to 50 m.
2. first partial region: Inner diameter 1.5 mm to 2.15 mm, length 1 m to 50 m; central partial region: Inner diameter 2.2 mm to 2.8 mm, length 1 m to 50 m; second partial region: Inner diameter 2.9 mm to 7 mm, length 1 m to 50 m.
3. first partial region: Inner diameter 1.5 mm to 2.0 mm, length 1 m to 50 m; second partial region: Inner diameter 2.1 mm to 11 mm, length 1 m to 50 m.
4. first partial region: Inner diameter 1.5 mm to 2.0 mm, length 1 m to 50 m; central partial region: Inner diameter 1.8 mm to 2.8 mm, length 1 m to 50 m; second partial region: Inner diameter 2.9 mm to 11 mm, length 1 m to 50 m.
5. first partial region: Inner diameter 1.5 mm to 2.19 mm, length 1 m to 50 m; first central partial region: Inner diameter 2.2 mm to 2.5 mm, length 1 m to 50 m; second central partial region: Inner diameter 2.51 mm to 3.5 mm, length 1 m to 50 m; second partial region: Inner diameter 3.6 mm to 14 mm, length 1 m to 50 m.

Preferred examples of such graduations are given in the examples in reactor setups 4-6, which can also be used for applications other than those shown in the examples.

Preferably, the length of the hollow body is larger than the width/diameter of the hollow body, in particular in the reaction zone, or a partial region thereof, e.g. in the first, second and/or third partial region. For example, the ratio of length to width (or to diameter instead of width) may be 50 or more, preferably 75 or more, more preferably 100 or more, in particular 125 or more, 150 or more, particularly preferably 200 or more, or 300 or more, particularly preferably 400 or more or 500 or more, in the hollow body, in particular in the reaction zone, or a partial region thereof, e.g. in the first, second and/or third partial region. This ratio of length to width (or to diameter instead of width) may be 50:1 to 20,000:1, in particular 75:1 to 15,000:1, or 100:1 to 10,000:1, or 200:1 to 5,000:1, especially preferably 400:1 to 2,000:1, in the hollow body, in particular in the reaction zone, or a partial region thereof, e.g. in the first, second and/or third partial region. This ratio should be present in particular in a reactor zone of the hollow body. In the case of staggered widths/diameters in partial regions, the width/diameter of the respective partial region may be used aliquot of the length of the partial region to the total length of the hollow body or the reactor zone or the average of the width/diameter. Particularly effective reactions are possible in hollow bodies with this length to width (or diameter) ratio.

Plastics (e.g. polytetrafluoroethylene—PTFE, polypropylene—PP, polyethylene—PE, polyvinyl chloride—PVC, polyvinylidene fluoride—PVDF, polychlorotrifluoroethylene—PCTFE, ethylenechlorotrifluoroethylene—ECTFE, perfluoroalkoxyalkane—PFA, perfluoroethylenepropylene—FEP, polyoxymethylene—POM, or the like), metals such as stainless steels (1.4301, 1.4404, 1.4571, 1.4539, 1.4547 or the like) or nickel-based alloys (2.4602, 2.4819, 2.4858 or the like) and the like are used as materials for the hollow body or the reactor in general.

The tube dimensions are preferably selected such that a surface-to-volume ratio of 350 m²/m³ to 6000 m²/m³, preferably 1000 m²/m³ to 3000 m²/m³, is achieved. This applies to the elongated hollow body as a whole, preferably also to each partial region individually.

Furthermore, the reactor-specific surface load is in the range from 2 l/hm² to 140 l/hm², preferably from 4 l/hm² to 40 l/hm². The reactor-specific surface load is a variable for the throughput (flow rate in 1/h) per surface in the elongated hollow body or in the reaction zone.

The reactor-specific volume load is preferably in the range from 300 l/hm³ to 23,000 l/hm³, preferably from 700 l/hm³ to 5000 l/hm³. The reactor-specific surface load is a variable for the throughput (flow rate in 1/h) per volume in the elongated hollow body or in the reaction zone.

In the method, the hydrodynamic residence time is preferably between 0.5 and 20 minutes, preferably between 2 and 15 minutes. The residence time may be adjusted by throughput (flow rate) for a given reactor. It indicates the average residence time of the reactants and the products polymerized therefrom together in the reaction zone.

If more conversion is desired, the inner diameter in the elongated hollow body, and possibly the length of the hollow bodies or its partial regions, is increased. Thus, with increasing conversion, an adjustment of the tube diameter can take place. Depending on the reaction enthalpy and a suitable combination of diameter and length of a partial region or tube element, a defined proportion of the heat of reaction can be compensated. Ideal reaction conditions result from a combination of maximum conversion with minimum pressure loss, residence time and temperature control.

The elongated hollow body is accommodated in a heating medium or a heat exchanger. The heat exchanger may consist of individual plates in which the hollow body is accommodated, embedded or surrounded by the heat exchanger. The plates can be provided individually or stacked in a number of 2-50. Depending on the expansion, several stacks may also be connected to each other. Preferably, the hollow bodies are introduced into plates, embedded, e.g. embedded in groove-shaped depressions in plates, or placed thereon, preferably in 1-30 plates. Such a structure is described in WO 2010/055034 A1 (incorporated herein by reference).

The plates and tubes may be made of a wide variety of materials, such as plastics (polytetrafluoroethylene—PTFE, polypropylene—PP, polyethylene—PE, polyvinyl chloride—PVC, polyvinylidene fluoride—PVDF, polychlorotrifluoroethylene—PCTFE, ethylenechlorotrifluoroethylene—ECTFE, perfluoroalkoxylalkane—PFA, perfluoroethylenepropylene—FEP, polyoxymethylene—POM, or the like), metals such as stainless steels (1.4301, 1.4404, 1.4571, 1.4539, 1.4547 or the like), nickel-based alloys (2.4602, 2.4819, 2.4858 or the like), and the like. Preferably, the plates consist of fiber-reinforced, especially glass-fiber-reinforced) plastic, aluminum or stainless steel. In these plates, the heating medium flows around the tubes in channels.

Depending on the configuration, one or more plates may be divided into individual temperature zones. Each temperature zone is kept at the desired temperature with an upstream temperature control.

The reaction temperature may be 10-80° C., preferably 20-60° C., preferably at least 25° C., particularly preferably at least 40° C.

The reactor or the reaction parameters are designed in such a way that they can be individually adapted to the specific prepolymer synthesis. For this purpose, tube elements (partial regions that together make up the reaction zone) are connected differently, the temperature (zones) is adapted and the residence time (throughput) is varied.

The process conditions described above are preferably selected in such a way that a conversion of 80-100%, preferably 95-100%, based on the NCO reactant is achieved at the end of the reaction zone (at the outlet) (all mass-%). For this purpose, the reaction dimensions (esp. length), temperature and concentrations, especially an excess of alcohol reactant.

After the outlet, the product may be collected or gathered in a collecting container. There are usually no polymerization conditions in the collecting container, e.g. a lower temperature, such as room temperature (e.g. 22° C.). It is also possible to prevent any polymerization by quenching. For this purpose, a monovalent reactant, preferably a monovalent alcohol, may be present in the collecting container.

A special feature of the reactor according to the invention is also that the reactor unit can be precisely matched to any reaction product (reaction enthalpy, molar mass, etc.).

The product quality is preferably monitored online, e.g. with infrared spectroscopy, refractive index, viscosity, density, titration and/or light(laser)diffraction measurement. Conversion and product quality can be determined directly after leaving the reactor (at the outlet) and/or on the product in the collecting container. For this purpose, the product may be examined inline/online by means of infrared (IR), viscosity, density, ultraviolet and visible light (UV-Vis), refractive index and titration analysis. The online results, such as the IR measurement, can be used directly to adjust the process conditions, such as reactant flow rates. In particular, the NCO conversion may be tracked by infrared spectroscopy.

The product container (as well as the reactant containers) is preferably flushed/overpressurized with inert gas and is anhydrous in order to prevent a change in the product qualities. The product is preferably temperature-controlled between −20° C. and 50° C. during storage or in the collecting container.

According to the invention, an aftertreatment may be carried out on the product prepolymer, which takes place after the reaction zone. It may be carried out in a collecting container for product prepolymer or also in the reactor in a hollow body, e.g. at a different temperature or without a catalyst, if this is necessary for the polymerization. The aftertreatment may be temperature adjustment, inertization, end group modification, or a combination thereof. End group modifications are, for example, obtaining aliphatically terminated polymer, e.g. by reaction with a monohydric alcohol; obtaining hydroxy-terminated polymer, e.g. by reaction with polyhydric alcohol; obtaining amine end groups, e.g. by reaction with water; obtaining amide end groups, e.g. by reaction with a carboxylic acid; or combinations thereof.

By using the reactor according to the invention and the reaction parameters, side reactions can be avoided and a higher reusability of the reactor can take place. Side reaction products may be, in particular, a possibly undesirable biuret, allophanate or high-grade urea formation, which have negative properties on the desired prepolymer, especially in the case of polyurethane prepolymer. This can lead to an excessively high molar mass and crosslinking. This results in sparingly soluble gel formation with very high viscosity. Gel may render the reactor unusable.

Depending on the requirements, an aftertreatment is carried out in a reaction zone or in the collecting container. Product quality can be fixed by adding additives. Depending on the degree of conversion, reactive end groups may still be present. Additives are used to set the desired end group reactivity. A distinction can be made primarily between NCO, amine, amides, hydroxyl and aliphatically terminated.

In order to achieve NCO-terminated polymers, the degree of conversion is controlled accordingly and storage/filling takes place inertly and anhydrously.

Amine-terminated polymers are achieved by adding precisely controlled amounts of water and rapid conversion in the reaction zone or in the collecting container.

Amide-terminated polymers are achieved by adding precisely controlled amounts of carboxylic acids in the reaction zone or in rapid conversion in the collecting container.

Hydroxy-terminated polymers are achieved by adding polyhydric polyols in the reaction zone or in the collecting container.

Aliphatically terminated polymers are achieved by adding monohydric alcohols in the reaction zone or in the collecting container.

Cleaning the reactor is also essential. The polymerization of the reactive components takes place in the entire process stream in the reaction zone. The polymerization is not only limited to the combination of different reactants. Due to their high activity, the reactants can also react or polymerize with themselves. In addition, there is the laminar flow over the entire process. As a result, reactive components can always be found in the stream up to the outlet or collecting container. This can lead to the above-mentioned side reactions (polyurea, allophane, biuret, gel formation and crosslinking). This disrupts production and, in the worst case, irreversibly blocks the reactor. Therefore, a regular flushing and a defined start/shutdown procedure is advantageous in order to be able to operate the process continuously. The flushing procedure may vary depending on the process step.

Depending on the product requirements, the flushing can be combined with the aftertreatment (fixing step). No inferior products are produced. An aftertreatment can be carried out towards the end of the reaction zone, after the reaction zone in the reactor or in the collecting container. The fixing agent may be a mono- or polyhydric alcohol.

In the case of product changeover or until medium length downtime (<7 days), it is preferably first flushed with a solvent with at least 4 reactor volumes. Suitable solvents have been described above, preferably DMAc. This is followed by a flushing of 4-10 reactor volumes from a solvent/fixative mixture, preferably 2:1 to 1:1 mixture. The exact amount of volume is determined by online measurement (IR). The flushing is completed when at least 2 reactor volumes no more reactant or prepolymer, especially no NCO reactant, is detected. If downtime is imminent, the inputs/outputs of all lines are closed airtight.

A more extensive procedure is recommended for downtimes from 7 days or when system parts are disassembled. Preferably, the flushing steps are carried out as with the medium length downtime. This is followed by flushing 4-8 reactor volumes with anhydrous fixing agent. Glycols and alcohols are particularly suitable for this purpose, but not limited thereto. The resulting insoluble components (oligomers, insoluble functionalized monomers) are removed with a further solvent flushing of about 4 reactor volumes. In the case of longer downtimes of >30 days or disassembly, a flushing sequence of about 4 reactor volumes each with 96% ethanol, ethanol/water 50% and water is still carried out.

In laboratory analysis, the macromolecular properties of the prepolymer and its purity can be investigated. These result from the reactants, their ratio and the polymer chain length. The chain length is determined by size exclusion chromatography (SEC) (e.g. with THF or DMSO, 35° C., butylhydroxytoluene (BHT) flow marker 30.6 ml ret. Vol., RI detector, polystyrene (PS) standards, PSS SDV column, 0.8 ml/min). The average molecular weight (Mw) of the prepolymer is preferably in the range from 4,000 Da to 80,000 Da, preferably 7,000 Da to 50,000 Da, particularly preferably 8,000 Da to 25,000 Da. The polydispersity Mw/Mn is preferably less than 4, preferably less than 2. The above parameters can be set to reach these ranges.

The chain length of the prepolymer directly influences the viscosity of the product. Therefore, product quality may also be determined by viscosity. A rheometer can be used for this (Anton Paar MCR102, CC27 measuring instrument, in cylinder, 25° C.). The preferred viscosity range is between 20 mPa*s to 30,000 mPa*s, preferably between 90 mPa*s to 7,000 mPa*s, particularly preferably 120 mPa*s to 5,000 mPa*s, at 25° C.

The method according to the invention, in particular for the preparation of a polyurethane prepolymer, is preferably operated in such a way that, for a given target molar mass M [Da] and a given prepolymer concentration in the product [m %], a target viscosity of 20 mPa*s to 30,000 mPa*s, or another viscosity range as stated above, according to the formula

$$η ( M , c ) = {A}_{M} * {e}^{{K}_{M} * M} * {A}_{PUR} * {e}^{{K}_{PUR} * {c}_{PUR}} * {A}_{η}$$

wherein μ(M, c) is the targeted viscosity, M is the target molecular weight [Da], c(PUR) is the prepolymer concentration in the product[m %], A(PUR) is 0.8319 mPa s, K(PUR) is 0.1561 m %⁻¹, A(M) is 73 mPa s, K(M) is 0.0000829 Da⁻¹, A(η) is 0.00502, is obtained. The target molar mass M [Da] and the targeted prepolymer concentration are as indicated above, e.g. a target molar mass Mw of 4,000 Da to 80,000 Da or 20%-60% (mass-%) or the preferred values indicated above. Preferably, the gravimetrically determined polymer content in the product (vacuum drying cabinet binder VDL 23, at 180° C., 3 h) is 10-60, preferably 30-50% (mass-%).

The specific density of the polymer product measured with the hydrometer (Carl-Roth, measuring ranges 0.75-1 and 1-1.1) is preferably 0.8-1.2, preferably 0.9-1.1.

The gravimetrically determined polymer content in the product (vacuum drying cabinet binder VDL 23, at 180° C., 3 h) is preferably 10%-60%, preferably 30%-50% (all mass-%).

The water content in the prepolymer (Karl Fischer, Metrohm 907 Titrando) is preferably below <4000 ppm, preferably <2500 ppm (mass ppm).

The metal content in particular of iron and copper (optical emission spectrometry with inductively coupled plasma—ICP-OES, Thermo Scientific iCAP 7400, in H₂SO₄) sum parameter is preferably <10, preferably ppm<4 ppm.

The product colour (yellow colouring) is a size to be able to draw conclusions about the quality and age of the prepolymer product. Visually, the color is preferably from colorless to slightly yellowish. The HAZEN color number (according to Pt/Co scale and/or according to DIN ISO 6271) (UV-Vis, Thermo Scientific Evolution 350) of the product is preferably <100, preferably <50.

Depending on the requirement, the remaining NCO content is significant (according to DIN EN ISO 14896, Metrohm 907 Titrando). If no NCO termination is desired, the residual NCO content should be <0.1%, preferably <0.05% (all mass-%).

The method according to the invention is freely scalable, preferably prepolymer with a conversion of 0.13 kg/h to 1536.8 kg/h or a multiple thereof is produced.

Polyurethane prepolymers are widely used in building materials, packaging, automotive, electrical, insulation, household, clothing, chemical additives and much more. The prepolymers according to the invention may be used in these areas. For example, use cases are the use for simpler and more intensive dyeing of fibers and end products. Prepolymers may be used as a color stabilizer to extend the color stability of products, e.g. in these areas of application.

The prepolymer according to the invention may be used as a spinning additive in (synthetic) fibre production. As a result, the production of fibres is improved in terms of procedural technology and the stability of the fibres. In general, the addition of prepolymers increases the resistance of plastics or fibers to degradation mechanisms via UV, light, oxidation and heat. The prepolymer may be used as a color stabilizer for polyurethane (PU) polymer (more strongly polymerized PU, e.g. no longer in the above solvent, such as DMAc, soluble PU). In particular, the prepolymer may be used to improve PU fiber spinning. In general, prepolymer may be used as a PU stabilizer.

The prepolymers may also be used as reactants for further polymerizations, e.g. as chain extenders. The prepolymers are combined with other monomers and chain extenders (such as polyalcohols, polyglycols (EtGlycol), polyacrylates, polyethers, polyesters and the like). Any polymers, such as PU, polyurea or other functionalized polymers, can be extended. This can also be done in combination with other chain extenders, such as polyalcohols, polyglycols, polyacrylates, polyethers or polyesters.

In particular embodiments, the invention is defined by the following numbered embodiments and aspects, all of which, of course, may be further combined by any of the parameters, embodiments, or aspects described herein.
1. A continuous method for producing a prepolymer in a reactor having an elongated hollow body, wherein at least two reactants are introduced continuously at one end of a reaction zone of the hollow body, the at least two reactants are polymerized in the reaction zone, and prepolymer is discharged at another end of the reaction zone,
wherein the elongated hollow body comprises at least a first and a second partial region in the reaction zone, wherein the hollow body has an inner diameter in the second partial region at least 10% larger than the inner diameter of the hollow body in the first partial region.
2. The method according 1, wherein the second partial region has a volume larger than the volume of the first partial region, preferably wherein the second partial region has a volume larger than the volume of the first partial region by at least 5%, preferably by at least 10%.
3. The method according to 1 or 2, wherein the prepolymer is a polyurethane prepolymer and one of the reactants comprises at least one alcohol group and one of the reactants comprises at least one isocyanate group.
4. The method according to 1 to 3, wherein the inner diameter in the second partial region is larger than the inner diameter of the first partial region by at least 20%, preferably by at least 30%, particularly preferably by at least 40%, particularly preferably by at least 50%.
5. The method according to 1 to 4, wherein the second partial region has a length that is larger than or equal to the length of the first partial region.
6. The method according to 5, wherein the second partial region has a length that is at least 10% larger than the length of the first partial region.
7. The method according to 1 to 6, wherein the first partial region is at the inlet into the reaction zone and/or the second partial region is at the outlet of the reaction zone.
8. The method according to 1 to 7, wherein the inner diameter has at least 3 diameter graduations over the length of the reaction zone.
9. The method according to 8, wherein a central partial region is provided between the first and second partial regions, wherein the central partial region has an inner diameter that is larger than the inner diameter of the first partial region and smaller than the inner diameter of the second partial region.
10. The method according to 8 or 9, wherein the second partial region comprises subregions with at least two different inner diameters, wherein a subregion closer to the first partial region has a smaller inner diameter than a subregion further from the first partial region.
11. The method according to 1 to 10, wherein the reaction zone has a length of at least 50 cm, preferably of at least 1 m; and/or the hollow body has an inner diameter of <2.2 mm in the first partial region and/or the hollow body has an inner diameter of ≥2.2 mm in the second partial region
12. The method according to 1 to 11, wherein the reaction zone has a volume of at least 25 ml, preferably of at least 100 ml, particularly preferably of at least 500 ml; and/or wherein the reaction zone has a volume of at most 5 l, preferably of at most 3 l, particularly preferably of at most 2 l.
13. The method according to 1 to 12, wherein the residence time of the reactants polymerizing to prepolymer and polymerized in the reaction zone is at least 2 min, preferably 3 min to 15 min, particularly preferably 4 min to 10 min.
14. The method according to 1 to 13, wherein the reactants are introduced into the reaction zone in a solution and the concentration of the reactants together is 20% to 60% (mass-%).
15. The method according to 1 to 14, wherein one of the reactants is introduced into the reaction zone in an excess over another of the reactants, preferably with an excess of at least 3% (mol-%), preferably 5% (mol-%), particularly preferably of at least 10% (mol-%).
16. The method according to 1 to 15, in combination with 3, for producing a polyurethane prepolymer, wherein the reactor is operated with a temperature (T), a residence time (t), and an optional molar excess of a reactant (c), so that a targeted average molecular weight of the prepolymer of 5000 Da to 80,000 Da according to the formula

$${M}_{k} ( T , t , c ) = {A}_{T} * {e}^{{K}_{T} * T} + {A}_{t} * t - {A}_{c} * c$$

wherein
Mₖ(T, t, c) is the targeted average molecular weight of the prepolymer,
A(T) is 0.00039 Da,
K(T) is 0.05733 K⁻¹,
A(t) is 1354 Da min⁻¹,
A(c) is 534 Da mol⁻¹,
T is the temperature in K,
t is the residence time in min,
c is the molar excess of a reactant in mol-%,
is obtained.
17. The method according to 1 to 16, wherein the elongated hollow body, preferably in the reaction zone, has a length-to-width ratio of 100:1 to 20,000:1.
18. The method according to 1 to 17, wherein in a partial region its width or its diameter remains substantially constant, wherein optional tube compressions are limited to less than 5% of the length of the hollow body or the reactor zone.
19. The method according to 1 to 18, wherein no mixer is used in the reaction zone.
20. A reactor suitable for carrying out a method according to 1 to 19, wherein the reactor has an elongated hollow body, with an inlet at one end and an outlet at another end of the hollow body, wherein the elongated hollow body comprises at least a first and a second partial region, wherein the hollow body in the first partial region has an inner diameter of <2.2 mm and the hollow body in the second partial region has an inner diameter of ≥2.2 mm, wherein the hollow body has an inner diameter in the second partial region at least 10% larger than the inner diameter of the hollow body in the first partial region.
21. The reactor according to 20, wherein the first and second partial regions each have a length of ≥1 m, independently of one another.
22. The reactor according to 20 or 21, wherein the second partial region has a length that is larger than or equal to the length of the first partial region.
23. The reactor according to 20, 21, or 22, wherein the second partial region has a volume larger than the volume of the first partial region, preferably wherein the second partial region has a volume larger than the volume of the first partial region by at least 5%, preferably by at least 10%.
24. A continuous method for producing a prepolymer in a reactor having an elongated hollow body, wherein at least two reactants are introduced continuously at one end of a reaction zone of the hollow body, the at least two reactants are polymerized in the reaction zone, and prepolymer is discharged at another end of the reaction zone,
wherein the elongated hollow body comprises at least a first and a second partial region in the reaction zone, wherein the hollow body has an inner diameter in the second partial region at least 10% larger than the inner diameter of the hollow body in the first partial region and the second partial region has a volume that is larger than the volume of the first partial region, and wherein preferably the reaction zone of the elongated hollow body has a length-to-width ratio of 75:1 or more; preferably combined with one of the 1 to 23.

The present invention is further illustrated by the following specific embodiments of the examples.

### EXAMPLES

### Example 1: Preparation of the Reactant Solutions and Temperature Control

Preparation of the isocyanate solution (reactant 1): reactant 1 is prepared by mixing 4,4-methylenebis (phenyl isocyanate) (MDI) (Sigma-Aldrich, 98%) with N,N-dimethylacetamide (DMAc) (Sigma-Adlrich, ≥99.8%). The MDI content is 10-70%, depending on the targeted polyurethane content in the product (see Table 1 column [B]). Depending on the pretreatment (see Table 1 column [I]), reactant 1 is still added at 1% based on the total solution of p-toluenesulfonyl isocyanate (TSI) (Sigma-Aldrich, 96%). As a drying agent, 5% molecular sieve (Carl-Roth, 4A, bead form) is added to the solution.

Preparation of the diol solution (reactant 2): reactant 2 is prepared from N-methyldiethanolamine (MDEA) (Sigma-Aldrich, ≥99%) in DMAc. The concentration is 30-100%, depending on the PUR content in the product (see Table 1 column [B]). As a drying agent, 5% (Carl-Roth, 4A, bead form) is added to the solution.

For the aftertreatment, solutions of fixing agents ethanol (EtOH) (Carl Roth, 99.5%, ultrapure), ethylene glycol (Carl Roth, 99%, for synthesis) and MDEA in DMAc were prepared. The concentration of fixing agent was 30% in each case. As a drying agent, 5% (Carl-Roth, 4A, bead form) was added to the solutions.

The solutions were prepared in a glove bag under a nitrogen atmosphere. The nitrogen used (Linde, 99.8%) was additionally passed over a drying column with glass wool and Sicapent (Merck, phosphorus pentoxide, with indicator) in order to reduce the humidity of the gas.

After preparation, the solutions were sealed with a septum and discharged. The reactants were integrated into the process stream under argon (Linde, 99.996) superposition.

During the entire procedure, the reactant and product containers were overpressurized with a slight argon overpressure (0.14-0.2 bar overpressure). All containers were equipped with septum to allow the addition of fixatives or additives (see Table 1 columns [H] and [I]).

The temperature was regulated with a water bath thermostat (Huber CC-205B). The thermostat is equipped with a cooling coil, which also allows temperatures below room temperature. The cooling medium is supplied externally from the building services system.

The process control was carried out online with a Fourier transform infrared spectrometer (FTIR) device (Bruker Alpha II). This was used to determine the residual isocyanate content.

Between each experiment, the reactor system was flushed with fixative solution ethanol (EtOH) with DMAC until no isocyanate was detectable in the FTIR FOR two reactor residence times.

### Example 2: Continuous Reactor 1 Experimental Series

The experimental series comprises experiments 1-9 from Table 1, Column [A]. The solution is prepared analogously to Example 1. A reactor as described in WO 2010/055034 A1 was used. In short, the reactor is a flow reactor, wherein the reaction takes place in one or more tubes. The reactants are supplied at one end of the tube system and the product is obtained at another end. The reactor is operated continuously. The tubes may be arranged in one or more plates.

For the first experimental series, the reactor with a volume of 17.5 ml was used (see Table 1 column [F]). Piston stroke pumps (Knauer Azure, P4.1S and P2.1S) were used to convey the media. The media were fed together into the reactor via a T connection. The product [B] was produced at a temperature [C] and a flow [D]. The parameters [H], [I], [M], [N], [O] and [P] were varied (Tables 1 and 2). The product showed a polyurethane content [B] and the associated properties [J], [K] and [L] according to Table 2. The dimensions of the tube system in Setup 1 are shown in the following table; the tubes are described in order from top to bottom. The total volume in the reactor is given below.

Table: Reactor Setup 1

| Inner | | Length |
|---|---|---|
| Diameter | Length | (L)/Inner |
| (D)/mm | (L)/m | Diameter (D) |
| 1.00 | 2.22 | 2200 |
| 1.50 | 1.11 | 740 |
| 2.00 | 0.56 | 280 |
| 2.16 | 0.56 | 259 |
| 2.32 | 0.56 | 241 |
| 2.98 | 0.56 | 188 |
| 4.00 | 0.3 | 75 |
| | 17.5 ml volume | |

Experiments with Setup 1 showed that this setup was not ideally suited. The residence times in the small diameters (<2.2 mm) are too long compared to the medium and large diameters (>=2.2 mm). This made it difficult to control the molar mass. Experiments 1-9 show that the molar mass varied between 243 017 Da and 8 913 Da despite relatively narrow temperature windows. In addition, two phase mixtures were observed in the end product in the experiments. The two-phase mixtures show that side reactions take place. The dominant side reactions are crosslinking and polyurea, allophane, biuret synthesis and (see literature [3]), which lead to gel formation. Exactly these side reactions and polyurea formation can also be seen in the examples of U.S. Pat. No. 7,795,359 B2.

The data on molecular weight, polydispersity and viscosity in Table 2 reflect the properties of the liquid phase. The gel phase was not analyzed because it is not soluble for GPC analysis and because the viscosity is outside the measurement range. The proportion of gel formation increased with each experiment, so the setup was expanded and reactor setup 2 was developed.

### Example 3: Continuous Reactor 2 Experimental Series

The experimental series comprises experiments 10-12 from Table 1, Column [A]. Here, reactor setup 1 was expanded by a reactor zone to increase conversion. Changing back from large to small diameter improves mixing. This leads to fewer side reactions, as the residence time distribution is reduced. This results in slight changes to the procedural parameters. Otherwise, the procedure was analogous to Example 2.

Table: Reactor Setup 2

| | | Length |
|---|---|---|
| Inner | | (L)/Inner |
| diameter/mm | Length/m | Diameter (D) |
| 1.00 | 2.22 | 2200 |
| 1.50 | 1.11 | 740 |
| 2.00 | 0.56 | 280 |
| 2.16 | 0.56 | 259 |
| 2.32 | 0.56 | 241 |
| 2.98 | 0.56 | 188 |
| 4.00 | 0.3 | 75 |
| 1.00 | 3.08 | 308 |
| 1.50 | 1.67 | 1113 |
| 2.00 | 1.11 | 555 |
| | 26.3 ml volume | |

As a result, gel formation could not be controlled. The jump back to small diameters and the frequent change of diameter (10) leads to many poorly flushed dead zones (laminar flow). The positive effect of increased mixing is therefore overcompensated by increasing the dead zones (negative effect). Here, too, it was not possible to separate the production from a (particularly preferred) prepolymer (see side reactions in Example 3; molar mass) and gel formation.

The tubes of Setup 2 were consequently completely blocked by gel formation after Experiment 12. The setup has was deactivated. The next step was to develop a simpler setup.

### Example 4: Continuous Reactor 3 Experimental Series

The experimental series comprises experiment 13 from Table 1, Column [A]. Here, it was tested how far the setup can be scaled down with only one reactor plate, resulting in a smaller reactor volume (Table 1, column [F]). In addition, the efficiency of the aftertreatment and cleaning was investigated. In addition, the setup serves as a pre-test for a more robust setup to eliminate the problems (money formation) from the first two setups. The procedure was analogous to Example 2.

Table: Reactor Setup 3

| | | Length |
|---|---|---|
| Inner | | (L)/Inner |
| diameter/mm | Length/m | Diameter (D) |
| 1.00 | 0.5 | 500 |
| 2.98 | 0.3 | 101 |
| | 2.5 ml volume | |

The results with this setup show good control of the setup. Very low molar masses could be produced in a targeted manner. Gel formation was not observed. However, the setup is not designed for high conversion volumes. Therefore, Setup 4 was developed.

### Example 5: Continuous Reactor 4 Experimental Series

The experimental series comprises experiments 14-22 from Table 1, Column [A]. From the findings of Examples 2-4, the reactor setup 4 with two plates was created, resulting in a larger reactor volume (Table 1, column [F]). Here, higher product contents [B] were achieved in combination with temperatures [C]. This example showed the highest yield with good product properties and their controllability. The procedure was analogous to Example 2.

Table: Reactor Setup 4

| | | Length |
|---|---|---|
| Inner | | (L)/Inner |
| diameter/mm | Length/m | Diameter (D) |
| 2.16 | 1.97 | 912 |
| 2.32 | 2.22 | 957 |
| 2.98 | 1.67 | 560 |
| | 28.2 ml volume | |

The construction of a small diameter (<2.2) with a larger proportion of medium and large diameters (>=2.2) proved to be advantageous in the synthesis. With this reactor system, it was possible for the first time to produce a wide range of products (different molar masses) without observing gel formation. Conversion was managed so well that the product quality remains stable even without quenching.

Gel formation also did not occur as a result, as was recognized in later experiments. The setup was then used again for the later experiments 28-29.

### Example 6: Continuous Reactor 5 Experimental Series

The experimental series comprises experiment 23 from Table 1, Column [A]. Based on Example 5, the reactor was multiplied by a factor of 4 (8 plates) to increase the throughput. The product properties remain the same as shown in Table 2. The procedure was analogous to Example 2.

Table: Reactor Setup 5

| | | Length |
|---|---|---|
| Inner | | (L)/Inner |
| diameter/mm | Length/m | Diameter (D) |
| 2.16 | 7.85 | 3634 |
| 2.32 | 8.88 | 3828 |
| 2.98 | 6.66 | 2235 |
| | 112.8 ml volume | |

In this setup, the reactor was scaled up for one experiment to get closer to industrial production. The geometric ratio was maintained and only reactor volume and throughput were increased. The product properties from experiment 23 were consistently good and without side reactions and gel formation.

### Example 7: Continuous Reactor 6 Experimental Series

The experimental series comprises experiment 24 from Table 1, Column [A]. Based on Example 5, the reactor was multiplied by a factor of 28 (4 reactors of 28 plates each) to increase the throughput. The product properties remain the same as shown in Table 2. Here, the tube diameters have been optimized due to the efficiency.

In order to enable the higher throughputs, the pump system was changed. Piston diaphragm pumps (Prominent Hydro H2PA, HP2AE040050SST0000R0000 and HP2AA040050SST000000000) with pulsation dampers (Prominent PZ000008) were used. The rest of the procedure was analogous to Example 2. Even with even higher conversion rates, the quality and controllability of product properties remains unchanged.

Table: Reactor Setup 6

| | | Length |
|---|---|---|
| Inner | | (L)/Inner |
| diameter/mm | Length/m | Diameter (D) |
| 1.50 | 12.21 | 8140 |
| 2.16 | 11.10 | 5139 |
| 2.32 | 23.31 | 10047 |
| 2.98 | 17.76 | 5960 |
| 4.00 | 5.55 | 1388 |
| 6.00 | 4.44 | 740 |
| 10.88 | 3.33 | 306 |
| | 789.6 ml volume | |

For an industrial reactor, a scale-up from Setup 5 to Setup 6 was tested. The geometric composition in the table above was chosen from the findings of the previous setups. The comparison of Setup 1 to 4 shows that in the geometric composition of the tubes, the medium and high diameters (>=2.2 mm) should make up the larger proportion in order to be able to control the product properties preferentially. Setup 2 also shows that a change back to smaller diameters and the number of diameter changes of 10 have a negative effect on product quality. Setup 4 shows that two diameter changes work well. In order to meet the criteria and to achieve the highest possible production volume, a maximum of 6 diameter changes was set for Setup 6. In particular, this setup can be divided between medium and larger diameters. Small diameters d1 are <2.2 mm, medium diameters d2>=2.2 mm and <4 mm, large diameters d3 are >=4 mm.

The product features of the setup are still good with high conversion. Increases in production are intended as a multiplication of this setup.

### Example 8: Continuous Reactor 7 Experimental Series

The experimental series comprises experiment 25 from Table 1, Column [A]. In order to test the procedural limits, a reactor with a small inner diameter (0.5-0.75 mm) was combined with higher temperatures (60° C.) and a short residence time (0.26 min). The procedure was analogous to Example 2. This example confirms the broad scope of the method.

Table: Reactor Setup 7

| | | Length |
|---|---|---|
| Inner | | (L)/Inner |
| diameter/mm | Length/m | Diameter (D) |
| 0.50 | 0.5 | 1000 |
| 0.75 | 0.56 | 747 |
| | 0.34 ml volume | |

Experiment 25 shows a product still in the broad range of polymer properties. The preferred molar masses or NCO residues are no longer reached. Conversion rates are also very limited and gel formation also occurs as a by-product.

### Example 9: Continuous Reactor 8 Experimental Series

The experimental series comprises experiments 26-27 from Table 1, Column [A]. In order to test the procedural limits, a reactor with a large inner diameter (10-12 mm) with a varying residence time (1.17-21.14 min) was combined. The procedure was analogous to Example 2. This example confirms the broad scope of the method.

Table: Reactor Setup 8

| | | Length |
|---|---|---|
| Inner | | (L)/Inner |
| diameter/mm | Length/m | Diameter (D) |
| 10.88 | 0.3 | 27.6 |
| | 27.9 ml volume | |

Similar to Setup 7, this setup can only be used to a limited extent. The course of the reaction is not taken into account. This leads to poor heat dissipation, especially at the beginning. This creates a temperature gradient along the flow profile. This leads to local overheating. These locally elevated temperatures lead to uncontrolled side reactions with gel formation. Experiments 26-27 showed strong gel formation. There is also an increase in polydispersity (PDI) to 4.68 and 3.04, respectively. The increase in PDI shows that the setup is moving away from the ideal residence time distribution. In addition, the setup was blocked by gel after the two experiments and could no longer be used.

Setup 4 with a similar volume (28.2 ml) is therefore clearly preferred.

### Example 10: Continuous Reactor 4 Experimental Series

The experimental series comprises experiments 28-29 from Table 1, Column [A]. In order to test the procedural and chemical limits, the reactor from Example 5 was tested with deviating experiment parameters. The procedure is analogous to Example 2 with the following deviations. The hydroxy-terminated reactant used was tert-butyldiethanolamine (TBDEA). Since the viscosity of the solution is higher at room temperature with TBDEA, the reactant was preheated (40-80° C.). This example confirms the broad scope of the method.

Reactor Setup 4 was used again for this example. It has proven to be very well suited to produce consistent product quality.

Reactor Setups 4, 5, and 6 provide the best configurations to best control polymer properties.

TABLE 1
Experiment parameters polyurethane (PUR) prepolymer synthesis part 1.

| | [B] | [C] | | [E] | | [G] | | |
|---|---|---|---|---|---|---|---|---|
| | c (PUR)- | T- | | C- | | NCO | | |
| | PUR | Tem- | [D] | Excess | [F] | residues | | |
| [A] | content | pera- | Throug | reac- | Reactor | by | [H] | [I] |
| Experiment | product/ | ture/ | hput | tant 2/ | volume/ | reactor/ | After- | Pre-treat- |
| No. | m % | K | ml/min | mol-% | ml | mol-% | treatment | ment |
| 1 | 8 | 298.15 | 6.45 | 5 | 17.5 | 10 | none | DMAc |
| 2 | 17 | 293.15 | 6.45 | 5 | 17.5 | 15 | none | DMAc |
| 3 | 35 | 293.15 | 6.67 | 5 | 17.5 | 20 | none | DMAc, TSI |
| 4 | 35 | 323.15 | 6.67 | 5 | 17.5 | 10 | none | DMAc, TSI |
| 5 | 35 | 293.15 | 2.23 | 5 | 17.5 | 5 | none | DMAc, TSI |
| 6 | 35 | 293.15 | 2.23 | 5 | 17.5 | 5 | EtOH | DMAc, TSI |
| | | | | | | | quench | |
| 7 | 35 | 293.15 | 4.44 | 5 | 17.5 | 7 | EtOH | DMAc, TSI |
| | | | | | | | quench | |
| 8 | 35 | 323.15 | 2.23 | 5 | 17.5 | 5 | EtOH | DMAc, TSI |
| | | | | | | | quench | |
| | | | | | | | after | |
| | | | | | | | 16 h | |
| 9 | 35 | 303.15 | 4.44 | 5 | 17.5 | 7 | EtOH | DMAc, TSI |
| | | | | | | | quench | |
| 10 | 35 | 323.15 | 4.5 | 15 | 26.3 | 4 | none | DMAc |
| 11 | 35 | 323.15 | 4.5 | 15 | 26.3 | 4 | MDEA | DMAc |
| | | | | | | | quench | |
| 12 | 35 | 323.15 | 4.5 | 15 | 26.3 | 4 | EtOH | DMAc |
| | | | | | | | quench | |
| 13 | 35 | 298.15 | 1.32 | 15 | 2.5 | 5 | EtOH | DMAc, |
| | | | | | | | quench | stirring |
| 14 | 40 | 303.15 | 3.95 | 22 | 28.2 | <1 | EtOH | DMAc, |
| | | | | | | | quench | stirring, TSI |
| 15 | 40 | 303.15 | 5.98 | 22 | 28.2 | 2 | EtOH | DMAc, |
| | | | | | | | quench | cooling, TSI |
| 16 | 40 | 303.15 | 3.95 | 22 | 28.2 | <1 | Etgly- | DMAc, TSI |
| | | | | | | | col | |
| 17 | 40 | 303.15 | 3.95 | 22 | 28.2 | <1 | MDEA | DMAc, TSI |
| 18 | 40 | 303.15 | 3.95 | 22 | 28.2 | <1 | none | DMAc, TSI |
| 19 | 45 | 313.15 | 3.95 | 22 | 28.2 | <1 | EtOH | DMAc, TSI |
| | | | | | | | quench | |
| 20 | 50 | 333.15 | 5.98 | 22 | 28.2 | <1 | EtOH | DMAc, TSI |
| | | | | | | | quench | |
| 21 | 55 | 353.15 | 5.98 | 22 | 28.2 | <1 | EtOH | DMAc, TSI |
| | | | | | | | quench | |
| 22 | 60 | 313.15 | 3.95 | 22 | 28.2 | <1 | EtOH | DMAc, TSI |
| | | | | | | | quench | |
| 23 | 40 | 303.15 | 15.8 | 22 | 112.8 | <1 | EtOH | DMAc, TSI |
| | | | | | | | quench | |
| 24 | 40 | 303.15 | 110.6 | 22 | 789.6 | <1 | EtOH | DMAc, TSI |
| | | | | | | | quench | |
| 25 | 35 | 333.15 | 1.32 | 30 | 0.34 | 6 | EtOH | DMAc, TSI |
| | | | | | | | quench | |
| 26 | 35 | 283.15 | 1.32 | 22 | 27.9 | <1 | EtOH | DMAc, TSI |
| | | | | | | | quench | |
| 27 | 35 | 313.15 | 23.92 | 22 | 27.9 | <1 | EtOH | DMAc, TSI |
| | | | | | | | quench | |
| 28 | 40 | 303.15 | 1.975 | 22 | 28.2 | <1 | EtOH | DMAc, TSI, |
| | | | | | | | quench | pre- |
| | | | | | | | | temperature |
| | | | | | | | | control |
| | | | | | | | | 40° C. |
| 29 | 35 | 303.15 | 3.95 | 22 | 28.2 | <1 | EtOH | DMAc, TSI, |
| | | | | | | | quench | pre- |
| | | | | | | | | temperature |
| | | | | | | | | control |
| | | | | | | | | 80° C. |

TABLE 2
Experimental parameters PUR prepolymer synthesis part 2.

| | | | | | | | [P] |
|---|---|---|---|---|---|---|---|
| | | | | | [N] | [O] | t- |
| | | | | | Reactor- | Reactor- | Hydrody- |
| | | | [L] | [M] | specific | specific | namic |
| [B] | [J] | | Viscosity/ | Surface/ | surface | volume | residence |
| Experiment | M-Mw/ | [K] | mPas | volume/ | load/ | load/ | time |
| No. | Da | PDI/- | (25° C.) | m²/m³ | 1/hm² | 1/hm³ | min |
| 1 | 72 073 | 2.83 | 392 | 1855 | 11.92 | 22114 | 2.71 |
| 2 | 63 043 | 2.17 | 776 | 1855 | 11.92 | 22114 | 2.71 |
| 3 | 113 269 | 3.85 | n.a. | 1855 | 12.33 | 22869 | 2.62 |
| 4 | 243 017 | 4.1 | n.a. | 1855 | 12.33 | 22869 | 2.62 |
| 5 | 205 199 | 1.44 | n.a. | 1855 | 4.12 | 7646 | 7.85 |
| 6 | 15 864 | 1.87 | 241 | 1855 | 4.12 | 7646 | 7.85 |
| 7 | 8 913 | 2.33 | 143 | 1855 | 8.20 | 15223 | 3.94 |
| 8 | 44 074 | 1.62 | 2462 | 1855 | 4.12 | 7646 | 7.85 |
| 9 | 16 141 | 1.35 | 281 | 1855 | 8.20 | 15223 | 3.94 |
| 10 | 44 587 | 1.96 | 2646 | 2105 | 4.88 | 10266 | 5.84 |
| 11 | 39 057 | 1.57 | 2208 | 2105 | 4.88 | 10266 | 5.84 |
| 12 | 38 569 | 1.74 | 2079 | 2105 | 4.88 | 10266 | 5.84 |
| 13 | 5 409 | 1.82 | 127 | 1752 | 18.08 | 31680 | 1.89 |
| 14 | 10 459 | 1.4 | 376 | 1599 | 5.25 | 8404 | 7.14 |
| 15 | 6 349 | 1.19 | 264 | 1599 | 7.96 | 12723 | 4.72 |
| 16 | 9 548 | 1.72 | 341 | 1599 | 5.25 | 8404 | 7.14 |
| 17 | 10 017 | 1.66 | 369 | 1599 | 5.25 | 8404 | 7.14 |
| 18 | 12 511 | 1.81 | 429 | 1599 | 5.25 | 8404 | 7.14 |
| 19 | 21 502 | 1.94 | 1928 | 1599 | 5.25 | 8404 | 7.14 |
| 20 | 89 058 | 2.53 | n.a. | 1599 | 7.96 | 12723 | 4.72 |
| 21 | 183 062 | 2.84 | n.a. | 1599 | 7.96 | 12723 | 4.72 |
| 22 | 25 053 | 1.65 | 29349 | 1599 | 5.25 | 8404 | 7.14 |
| 23 | 13 634 | 1.47 | 453 | 1599 | 5.25 | 8404 | 7.14 |
| 24 | 14 539 | 1.56 | 497 | 1599 | 5.25 | 8404 | 7.14 |
| 25 | 53 283 | 2.13 | 4860 | 6156 | 37.84 | 232941 | 0.26 |
| 26 | 19 526 | 4.68 | 384 | 367 | 7.73 | 2839 | 21.14 |
| 27 | 12 957 | 3.04 | 218 | 367 | 140.02 | 51441 | 1.17 |
| 28 | 24 247 | 1.83 | 1256 | 1599 | 2.63 | 4202 | 14.28 |
| 29 | 11 036 | 2.19 | 193 | 1599 | 5.25 | 8404 | 7.14 |

TABLE 3
Experimental parameters PUR prepolymer synthesis part

| | | [R] | [S] | [T] |
|---|---|---|---|---|
| | [Q] | Water | Metal | HAZEN |
| [B] | Specific | content | content | color |
| Experiment | density | PUR | (Fe + Cu) | number |
| No. | [−] | [ppm] | [ppm] | [ppm] |
| 1 | 1.1 | >4 000 | n.a. | 248 |
| 2 | 1.1 | >4 000 | 4.7 | 287 |
| 3 | >1.2 | n.a. | n.a. | 347 |
| 4 | >1.2 | n.a. | n.a. | 263 |
| 5 | >1.2 | n.a. | n.a. | 211 |
| 6 | 1.05 | 3 168 | 3.6 | 184 |
| 7 | 1 | 3 864 | 3.1 | 238 |
| 8 | 1 | n.a. | n.a. | 157 |
| 9 | 1 | n.a. | n.a. | 189 |
| 10 | 1.2 | n.a. | n.a. | 162 |
| 11 | 1.2 | n.a. | n.a. | 158 |
| 12 | 1.2 | 2 841 | 3.2 | 174 |
| 13 | 0.95 | 2 593 | 3.0 | 167 |
| 14 | 1.1 | 1 849 | 3.9 | 128 |
| 15 | 1.05 | n.a. | n.a. | 152 |
| 16 | 1.1 | 1 527 | 2.4 | 86 |
| 17 | 1.1 | 1 473 | 3.6 | 74 |
| 18 | 1.1 | 1 892 | 3.1 | 63 |
| 19 | 1.15 | n.a. | n.a. | 42 |
| 20 | >1.2 | n.a. | n.a. | 183 |
| 21 | >1.2 | n.a. | n.a. | 163 |
| 22 | >1.2 | n.a. | n.a. | 159 |
| 23 | 1.1 | n.a. | n.a. | 107 |
| 24 | 1.1 | n.a. | n.a. | 73 |
| 25 | >1.2 | n.a. | n.a. | 284 |
| 26 | 1.1 | 1 275 | 3.4 | 53 |
| 27 | 1.05 | n.a. | n.a. | 75 |
| 28 | 1.15 | n.a. | n.a. | 118 |
| 29 | 1 | n.a. | n.a. | 41 |

In some experiments, the viscosity (>100,000 mPa s) could not be determined (n.a.). This is outside the target range. This occurs when high molar masses and high polyurethane contents coincide.

In experiments 1-5, high proportions of isocyanate residues were present after the reactor. Without aftertreatment, the product reacted and very high molar masses then occur. In addition to the high molar masses, side reactions can also occur. This further increased the viscosity. These product properties do not correspond to the target, because the molar mass directly after the reactor could not be determined by post-reactions.

For this purpose, a model was developed in order to be able to predict the product properties, in particular the molecular weight and viscosity, as a function of the reaction parameters. The model is valid for the ranges mentioned for molar mass, temperature, molar ratio and residence time. The residence time is also indirectly dependent on the procedural parameters such as flow rate, volume, surface/volume ratio, the reactor-specific surface load and the reactor-specific volume load. The model was derived as follows.

Various approaches were used for modelling. The influence of temperature is analogous to Arrhenius with the general formula:

$${k}_{T} = {A}_{T} * {e}^{\frac{- {E}_{A}}{RT}}$$

where:
k(T)—reaction rate constant as a function of temperature (2nd order) [m³ mol⁻¹ s⁻¹]
A(T)—pre-exponential factor temperature [-]
E(A)—Activation energy [J mol⁻¹]
R—Universal gas constant [8.314 J K⁻¹ mol⁻¹]
T—Temperature [K]

Based on Arrhenius, the formula is simplified as follows. Two constants remain to determine the temperature dependence.

$${k}_{T} = {A}_{T} * {e}^{{K}_{T} * T}$$

where:
k(T)—reaction rate constant or molar mass influence of temperature [Da]
K(T)—exponential factor temperature [K⁻¹]
A(T)—pre-exponential factor temperature [Da]
T—Temperature [K]
   This results in the temperature influence.

The residence time is a logarithmic function overall. In the range defined here, the influences are in the range of the steep gradient. In order to simplify the calculation, a linear approach was therefore used for the residence time. Especially because at a residence time of 0, the maximum average molecular weight of the monomers is reached.

This results in the following for the dependence of the residence time:

$${k}_{t} = {A}_{t} * t$$

where:
k(t)—reaction rate constant or molar mass influence as a function of the residence time [Da]
A(t)—linear factor residence time [Da min⁻¹]
t—residence time [min]

The third major influencing factor is the molar excess of a monomer (reactant). The higher the excess, the smaller molar masses are achieved. Conversely, high molar masses are only achieved at almost identical ratios. Therefore, the maximum is given for equal amounts of monomers and the minimum for a full excess of a monomer. The general tendency is followed by an exponential function with a negative exponent.

In the production of prepolymers, lower molar masses are preferred and therefore a monomer is usually present in excess. Depending on the product, this can be between 2-30%, preferably between 5-22%. In this range, a corresponding accuracy takes place with a linear compensation.

Thus, the following results for the dependence of the molar excess:

$${k}_{c} = {A}_{c} * c$$

wherein:
k(c)—reaction rate constant or molar mass influence as a function of the excess [Da]
A(c)—linear factor molar excess of a monomer [Da mol⁻¹]
c—molar excess of a monomer [mol-%]

If these three dependencies are now combined, the expected molecular weight can be calculated according to:

$${M}_{k} ( T , t , c ) = {k}_{T} + {k}_{t} - {k}_{c}$$

This corresponds to the following overall formula after insertion:

$${M}_{k} ( T , t , c ) = {A}_{T} * {e}^{{K}_{T} * T} + {A}_{t} * t - {A}_{c} * c$$

where:
Mₖ(T, t, c)—molar mass depending on temperature, residence time and concentration [Da].

In this overall formula for the molar mass dependence, the experimental data for temperature T (see Table 1—column C), excess c (see Table 1—column E) and residence time (see Table 2—column P) are now inserted.

The next step is to determine the constants for the model. In the first step, experiments in which only one parameter from temperature T, excess c and residence time t varies were used for compensation. Linear compensation was used for temperature and excess c. The temperature is compensated exponentially. This results in the starting values for the constants A(T), K(T), A(t) and A(c).

Deviation of model and experiments was achieved by minimizing the error squares. As secondary conditions, a maximum individual value deviation of the molar mass from model to experiment of ≤25% was tolerated. In addition, an average deviation of ≤12% was defined as a secondary condition. For the modeling of the constants A(T), K(T), A(t) and A(c), the generalized reduced gradient (GRG) method was used for non-linear systems of equations.

To validate the constants, the starting values for the modelling were doubled or halved. Various other local minimums were found for the costumers in the solution level. No result found resulted in a significant improvement in model accuracy with regard to error squares and mean deviation.

After modeling and rounding the non-significant digits, the numerical values for the constants are as follows:

$$A ( T ) - 0.00039 Da$$

$$K ( T ) - 0.0 \; 5733 {K}^{- 1}$$

$$A ( t ) - 1354 Da {min}^{- 1}$$

$$A ( c ) - 534 Da {mol}^{- 1}$$

Viscosity is an important point for the further use of the products as well as production. Too high a viscosity makes it difficult to convey both during use and during production. In addition, it is difficult to further process or admix it at high viscosity. Too low a viscosity again reduces the yield. Therefore, a maximum permissible viscosity for the desired product properties is the goal.

With the expected PUR content in the product and the molar mass, the viscosity can be calculated according to:

$$η ( M , c ) = {η}_{M} {η}_{c} * {A}_{η}$$

where
η(M, c)—total viscosity as a function of molecular weight and concentration [mPa s]
η(M)—Viscosity as a function of molecular weight [mPa s]
η(c)—Viscosity as a function of PUR concentration [mPa s]
A(η)—Dependency Balancing Factor [-]

Molar mass and polymer concentration influence the viscosity exponentially. Therefore, the following model formulas were used for the two factors:

$${η}_{M} = {A}_{M} * {e}^{{K}_{M} * M}$$

$${η}_{c} = {A}_{P U R} * {e}^{{K}_{P U R} * {c}_{P U R}}$$

where
A(M)—pre-exponential factor molecular weight [mPa s]
K(M)—exponential factor molecular weight [Da⁻¹]
A(PUR)—pre-exponential factor PUR concentration [mPa s]
K(PUR)—exponential factor PUR concentration [m %⁻¹]
M—molar mass [Da]
c(PUR)—PUR concentration product[m %]

After use, this corresponds to the following relationship between viscosity and polymer properties:

$$η ( M , c ) = {A}_{M} * {e}^{{K}_{M} * M} * {A}_{P U R} * {e}^{{K}_{P U R} * {c}_{P U R}} * {A}_{η}$$

In this formula for viscosity dependence, the experimental data for PUR content in the product—c(PUR) (see Table 1—column B) and molar mass—M (see Table 2—column J) are now used.

The next step is to determine the constants for the model. In the first step, experiments in which a parameter of PUR content c(PUR) and molar mass M varied were used for compensation. For the selected experiments, for the PUR salary compensation, the molar mass range of 8-22 000 Da was chosen.

Exponential compensation takes place in each case. This results in starting values for the constants A(PUR), K(PUR), A(M) and K(M). These initial values were in turn used for the experiments used with the same PUR content and molar mass. For the “same” molar mass, an average value was formed from the molar masses used for the molar mass window. The viscosities calculated with this η(M, c) at the same molecular weight η(M) or PUR content η(c) show a deviation from the viscosities from the experiments. The deviation is a multiplier factor. The mean value of the deviation factors thus results in the starting value for the factor of dependency compensation A(η).

Slight deviation of model and experiments was achieved by minimizing the error squares. As a secondary condition, a maximum individual value deviation of the viscosity from model to experiment of ≤20% was tolerated. In addition, an average deviation of ≤7% was defined as a secondary condition. For the modelling of the constants A(PUR), K(PUR), A(M), K(M), A(q), the generalised reduced gradient method was used for non-linear systems of equations.

To validate the constants, the starting values for the modelling were doubled or halved. Various other local minimums were found for the costumers in the solution level. No result found resulted in a significant improvement in model accuracy with regard to error squares and mean deviation.

After modeling and rounding the non-significant digits, the numerical values for the constants are as follows:

$$A ( PUR ) - 0.8319 mPa s$$

$$K ( PUR ) - 0.1561 m {\%}^{- 1}$$

$$A ( M ) - 73 mPa s$$

$$K ( M ) - 0.0000829 {Da}^{- 1}$$

$$A ( η ) - 0.00502$$

With the model and the method, both product properties and reaction conditions could be predicted.

1. A continuous method for producing a prepolymer in a reactor having an elongated hollow body, wherein at least two reactants are introduced continuously at one end of a reaction zone of the hollow body, the at least two reactants are polymerized with one another in the reaction zone, and prepolymer is discharged at another end of the reaction zone,
wherein the elongated hollow body comprises at least a first and a second partial region in the reaction zone, wherein the hollow body has an inner diameter in the second partial region at least 10% larger than the inner diameter of the hollow body in the first partial region, and the second partial region has a length larger than or equal to the length of the first partial region; and wherein the reaction zone of the elongated hollow body has a length-to-width ratio of 100:1 to 20,000:1.

2. The method according to claim 1, wherein the prepolymer is a polyurethane prepolymer and one of the reactants comprises at least one alcohol group and one of the reactants comprises at least one isocyanate group.

3. The method according to claim 1, wherein the inner diameter in the second partial region is larger than the inner diameter of the first partial region by at least 20%.

4. The method according to claim 1, wherein the second partial region has a length that is at least 10% larger than the length of the first partial region.

5. The method according to claim 1, wherein the first partial region is at the inlet into the reaction zone and/or the second partial region is at the outlet of the reaction zone.

6. The method according to claim 1, wherein the inner diameter has at least 3 diameter graduations over the length of the reaction zone.

7. The method according to claim 6, wherein a central partial region is provided between the first and second partial regions, wherein the central partial region has an inner diameter that is larger than the inner diameter of the first partial region and smaller than the inner diameter of the second partial region.

8. The method according to claim 6, wherein the second partial region comprises subregions with at least two different inner diameters, wherein a subregion closer to the first partial region has a smaller inner diameter than a subregion further from the first partial region.

9. The method according to claim 1, wherein the reaction zone has a length of at least 50 cm; and/or the hollow body has an inner diameter of <2.2 mm in the first partial region and/or the hollow body has an inner diameter of ≥2.2 mm in the second partial region.

10. The method according to claim 1, wherein the reaction zone has a volume of at least 25 ml; and/or wherein the reaction zone has a volume of at most 5 ml.

11. The method according to claim 1, wherein the residence time of the reactants polymerizing to prepolymer and polymerized in the reaction zone is at least 2 min.

12. The method according to claim 1, wherein the reactants are introduced into the reaction zone in a solution and the concentration of the reactants together is 20% to 60% (mass-%).

13. The method according to claim 1, wherein one of the reactants is introduced into the reaction zone in an excess over another of the reactants, preferably with an excess of at least 3% (mol-%).

14. The method according to claim 2 for producing a polyurethane prepolymer, wherein the reactor is operated with a temperature (T), a residence time (t), and an optional molar excess of a reactant (c), so that a targeted average molecular weight of the prepolymer of 5000 Da to 80,000 Da according to the formula
$${M}_{k} ( T , t , c ) = {A}_{T} * {e}^{{K}_{T} * T} + {A}_{t} * t - {A}_{c} * c$$
wherein
Mₖ(T, t, c) is the targeted average molecular weight of the prepolymer, A(T) is 0.00039 Da,
K(T) is 0.05733 K⁻¹,
A(t) is 1354 Da min⁻¹,
A(c) is 534 Da mol⁻¹,
T is the temperature in K,
t is the residence time in min,
c is the molar excess of a reactant in mol-%,
is obtained.

15. The method according to claim 2, wherein the second partial region has a volume larger than the volume of the first partial region, preferably wherein the second partial region has a volume larger than the volume of the first partial region by at least 5%.

16. A reactor suitable for carrying out a method according to claim 1, wherein the reactor has an elongated hollow body, with an inlet at one end and an outlet at another end of the hollow body, wherein the elongated hollow body comprises at least a first and a second partial region, wherein the hollow body in the first partial region has an inner diameter of <2.2 mm and the hollow body in the second partial region has an inner diameter of ≥2.2 mm, wherein the hollow body has an inner diameter in the second partial region at least 10% larger than the inner diameter of the hollow body in the first partial region, the first and second partial regions, independently of one another, each have a length of ≥1 m, and the second partial region has a length that is larger than or equal to the length of the first partial region, and wherein the reaction zone of the elongated hollow body has a length-to-width ratio of 100:1 to 20000:1.

17. The reactor according to claim 16, wherein the second partial region has a volume larger than the volume of the first partial region, preferably wherein the second partial region has a volume larger than the volume of the first partial region by at least 5%.
